(19) United States
(12) Patent Application Publication
(10) Pub. No.: US 2015/0186853 A1
(43) Pub. Date: Jul. 2, 2015

(54) PAYMENT TERMINAL, INFORMATION PROCESSING SERVER, PAYMENT TERMINAL CONTROL METHOD, AND PROGRAM PRODUCT

(71) Applicant: Wataru Suzukake, Shinagawa-ku (JP)

(72) Inventor: Wataru Suzukake, Shinagawa-ku (JP)

(73) Assignee: RAKUTEN EDY, INC., Tokyo (JP)

(21) Appl. No.: 14/410,879

(22) PCT Filed: Jun. 29, 2012
(86) PCT No.: PCT/JP2012/066819

§ 371 Date: Dec. 23, 2014

(51) Int. Cl. G06Q 20/06; G06Q 20/34

(52) U.S. Cl. CPC G06Q 20/065; G06Q 20/341

(57) ABSTRACT

The purpose of this server-managed electronic money system is to free the user from procedures required to use electronic money, allowing the electronic money to be used in approximately as short a time as stored-value electronic money systems. A portable terminal internally stores a mirror value of the server-side value balance, and an electronic money server stores the server-side value balance. When making a payment, a payment terminal either subtracts the payment amount from the mirror value, or, by referring to the mirror value, allows the user to complete the payment. By doing so, it is possible to complete payments as quickly as with stored-value electronic money. Later, an online request is made to the electronic money server to reduce (update) the server-side value balance.

### TECHNICAL FIELD

The present invention relates to payment terminals, information processing servers, payment terminal control methods, and program products, and, for example, relates to what performs payment processing by using electronic money.

### BACKGROUND ART

In recent years, the use of electronic money has become widespread. In electronic money, amount information called value is related to money value and fund settlement is performed by increasing or decreasing the balance of value.

### Existing Example 1

FIG. 12 is a diagram for explaining an electronic money system of Existing Example 1.

An electronic money card 90 is an IC card owned by the user, and the balance of value, an IC chip ID by which an IC chip is identified, an electronic money number, and so forth are recorded on a built-in IC chip. Moreover, a portable terminal 5, such as a mobile telephone, which incorporates the IC chip is also present.

A method of holding value by an IC chip on the user's side as described above is called a stored value type.

An asynchronous payment terminal 7 is installed in a store, an automatic vending machine, and so forth, and performs payment by value by reducing the value balance stored in the IC chip by performing short-distance radio communication (near field radio communication) with the electronic money card 90 or the IC chip of the portable terminal 5.

The asynchronous payment terminal 7 completes the payment processing locally between the asynchronous payment terminal 7 and the IC chip of the user without connecting to an electronic money server 2 and records the transaction history as log data.

Then, the asynchronous payment terminal 7 collectively sends the log data to the electronic money server 2 later at regular or irregular intervals.

The reason why the asynchronous payment terminal 7 is called “asynchronous” is that the asynchronous payment terminal completes the payment processing locally without being synchronous with the electronic money server 2.

FIG. 13 is a flowchart of the payment processing procedure (the electronic money processing procedure called a stored value type using the asynchronous payment terminal) of Existing Example 1.

Next, the asynchronous payment terminal 7 accepts entry of payment amount information from an employee of a store, for example (step 5). When the user sets, on the asynchronous payment terminal 7, the electronic money card 90 or the portable terminal 5 on which value used for payment is recorded, the asynchronous payment terminal 7 performs polling on the IC chip (step 15).

In response to this, the IC chip returns a response to the asynchronous payment terminal 7 (step 20). At that time, the IC chip sends the IC chip ID thereof to the asynchronous payment terminal 7.

When receiving the response from the IC chip, the asynchronous payment terminal 7 requests an electronic money number from the IC chip (step 25). The electronic money number is information by which the IC chip is identified in the electronic money server 2.

When there is a request for the electronic money number from the asynchronous payment terminal 7, the IC chip sends the electronic money number to the asynchronous payment terminal (step 30).

When receiving the electronic money number from the IC chip, the asynchronous payment terminal 7 requests authentication information from the IC chip (step 35).

In response to this, the IC chip sends the authentication information to the asynchronous payment terminal 7 (step 40).

The asynchronous payment terminal 7 receives the authentication information from the IC chip, authenticates the IC chip, and requests the IC chip to provide notification of the balance of value (step 45).

When receiving the balance request from the asynchronous payment terminal 7, the IC chip sends the balance of value that is currently recorded thereon to the asynchronous payment terminal 7 (step 50).

When receiving the balance from the IC chip, the asynchronous payment terminal 7 requests the IC chip to perform balance update in such a way as to update the balance of value to an amount after payment (step 55).

When receiving the balance update request from the asynchronous payment terminal 7, the IC chip updates the balance of the value (step 60) and sends an update completion notification to the asynchronous payment terminal 7 (step 65).

When receiving the update completion notification from the IC chip, the asynchronous payment terminal 7 informs the user of the completion of payment by sound, display, flashing of a lamp, or the like (step 70) and creates log data about the payment made this time in a state in which the log data is related to the electronic money number received from the IC chip (step 72), and ends the payment processing. This is the transaction of one unit of the asynchronous payment processing performed by the asynchronous payment terminal 7.

The asynchronous payment terminal 7 accumulates the log data by the above procedure and sends the log data to the electronic money server 2 by batch processing later (for example, about once a day) (step 75). The electronic money server 2 receives the log data from the asynchronous payment terminal 7 and records the log data (step 80).

As described above, in <Existing Example 1> described above, the balance of value is recorded on the IC chip and is processed locally between the IC chip and the asynchronous payment terminal 7. That is, <Existing Example 1> described above is a mechanism based on the premise that the electronic money server 2 does not grasp in real time fluctuations in the balance which is recorded on the IC chip.

Incidentally, at the time of filing of this application, many of the payment terminals placed in member stores that can make payment by electronic money operate in an asynchronous manner. This is due to circumstances under which, for example, it is difficult to perform payment processing in the electronic money server 2 in real time by connecting the electronic money server 2 and the payment terminal at all times due to restrictions on the communications capacity of a network.

However, the communications capacity of the network has been remarkably improved, and a server management-type system that manages value with a server and performs payment processing on the server's side has also become known (refer to, for example, Patent Document 1). It is expected that, with the improvement of a network infrastructure, such a server management-type system will become gradually widespread. Incidentally, electronic money of the type that manages value with a server will be referred to as server-type electronic money.

### Existing Example 2

FIG. 14 is a flowchart of the processing procedure (the processing procedure of server-type electronic money) of Existing Example 2. Incidentally, in a system of server-type electronic money, since value is not managed by an IC chip, it is necessary to synchronize it with value managed by the electronic money server 2 at all times. Therefore, a payment terminal used is a synchronous-type payment terminal, not an asynchronous-type payment terminal.

First, the payment terminal accepts entry of payment amount information from an employee of a store, for example (step 5) and performs polling on an IC chip (step 15).

In response to this, the IC chip returns a response to the payment terminal (step 20). At that time, the IC chip sends the IC chip ID thereof to the payment terminal. When receiving the response from the IC chip, the payment terminal requests an electronic money number from the IC chip (step 25). The electronic money number is information by which the IC chip is identified in the electronic money server 2.

When there is a request for the electronic money number from the payment terminal, the IC chip sends the electronic money number to the payment terminal (step 30).

Then, the payment terminal sends a payment request to the electronic money server 2 (step 85). This payment request includes the electronic money number acquired from the IC chip and the payment amount whose entry has been accepted.

The electronic money server 2 identifies an account identified by the received electronic money number (step 90). Then, the electronic money server 2 performs payment processing by updating the value balance recorded on this account (step 95).

Then, the electronic money server 2 sends an update completion notification to the payment terminal (step 100). When receiving the update completion notification from the electronic money server 2, the payment terminal informs the user of the completion of payment by sound, display, flashing of a lamp, or the like (step 105) and ends the processing. This is the transaction of the payment processing performed by the synchronous payment terminal.

### CITATION LIST

### Patent Literature

Patent Document 1: JP-A-2004-171527

### DISCLOSURE OF INVENTION

### Problem to be Solved by the Invention

The payment terminal that performs synchronous payment processing of <Existing Example 2> described above waits for a notification from the electronic money server, the notification indicating that the value balance has been changed on the electronic money server's side, and informs the user of the completion of payment processing. Therefore, as compared to the asynchronous payment processing of <Existing Example 1> described above, the user who performs the payment procedure is made to stay at the same place for a longer period of time.

As a result, for example, the following inconvenient situation may arise.
When payment is made by electronic money in a real store or the like, the user who makes payment and other users waiting for their turns are made to wait for a longer period of time.
When a fare is paid by electronic money in a train station or the like, a smooth passage of the user who tries to pay the fare and go through an automatic ticket wicket and the user who is following him/her is hindered.
This gives the user who has got used to payment of existing stored value-type electronic money a feeling of strangeness, and the user accidentally moves an electronic money card or a portable terminal having a built-in IC chip during payment processing. This eventually increases the probability of the occurrence of an error.

A problem to be solved by the present invention is to release the user from the procedure for using electronic money in a time which is nearly equal to the time of a stored value-type electronic money system in a system of server-type electronic money.

### SUMMARY OF THE INVENTION

The invention described in claim 1 provides a payment terminal comprising: a payment amount acquiring means that acquires a payment amount; a determining means that determines whether or not immediate connection to an information processing server is possible, the information processing server that is accessible to a balance storing means that stores a balance of server-side electronic value in a state in which the balance is associated with terminal identification information by which a money terminal is identified; a reference amount acquiring means that acquires, from the money terminal, a reference amount of the balance of server-side electronic value, the reference amount stored in the money terminal, after the determining means determines that immediate connection is possible; a notifying means that notifies the information processing server of the payment amount in a state in which the payment amount is associated with the terminal identification information of the money terminal, such that the balance of server-side electronic value stored in the balance storing means is reduced by the payment amount before new payment processing is started if the payment amount is less than or equal to the reference amount; and an outputting means that outputs information indicating completion of payment processing with the money terminal, the payment processing related to the payment amount, without waiting for a response to the notification made by the notifying means if the payment amount is less than or equal to the reference amount.

The invention described in claim 2 provides the payment terminal according to claim 1, wherein the money terminal further stores a balance of terminal-side electronic value, the payment terminal further comprises a terminal-side value balance updating means that sends reduction information to the money terminal, such that the balance of terminal-side electronic value stored in the money terminal is reduced by an amount of difference between the payment amount and the reference amount if the payment amount is not less than or equal to the reference amount, and the notifying means notifies the information processing server of the reference amount in a state in which the reference amount is associated with the terminal identification information of the money terminal, such that the balance of server-side electronic value stored in the balance storing means is reduced by the reference amount before new payment processing is started if the payment amount is not less than or equal to the reference amount.

The invention described in claim 3 provides the payment terminal according to claim 1 or 2, further comprising: a terminal-side reference amount updating means that sends reduction information to the money terminal, such that the reference amount is reduced by the payment amount if the payment amount is less than or equal to the reference amount, wherein the outputting means outputs information indicating completion of payment processing with the money terminal, the payment processing related to the payment amount, after the reference amount is reduced by the payment amount.

The invention described in claim 4 provides the payment terminal according to claim 3, wherein the money terminal further stores a number of times of reference indicating a number of times the reference amount is referred to, and the terminal-side reference amount updating means sends invalidation information to the money terminal, such that the reference amount is invalidated if the number of times of reference acquired from the money terminal is more than or equal to a predetermined threshold value.

The invention described in claim 5 provides an information processing server comprising: a server-side value balance reducing means that reduces the balance of server-side electric value stored in the balance storing means by the amount notified from the notifying means of the payment terminal according to claim 1 or 2; and a sending means that sends reduction information to the money terminal, such that the reference amount stored in the money terminal is reduced by the amount reduced from the balance of server-side value.

The invention described in claim 6 provides a payment terminal control method comprising: a payment amount acquiring step of acquiring a payment amount; a determining step of determining whether or not immediate connection to an information processing server is possible, the information processing server that is accessible to a balance storing means that stores a balance of server-side electronic value in a state in which the balance is associated with terminal identification information by which a money terminal is identified; a reference amount acquiring step of acquiring, from the money terminal, a reference amount of the balance of server-side electronic value, the reference amount stored in the money terminal, after determination is made in the determining step that immediate connection is possible; a notifying step of notifying the information processing server of the payment amount in a state in which the payment amount is associated with the terminal identification information of the money terminal, such that the balance of server-side electronic value stored in the balance storing means is reduced by the payment amount before new payment processing is started if the payment amount is less than or equal to the reference amount; and an outputting step of outputting information indicating completion of payment processing with the money terminal, the payment processing related to the payment amount, without waiting for a response to the notification output in the notifying step if the payment amount is less than or equal to the reference amount.

The invention described in claim 7 provides a program product for making a computer implement: a payment amount acquiring function of acquiring a payment amount; a determining function of determining whether or not immediate connection to an information processing server is possible, the information processing server that is accessible to a balance storing means that stores a balance of server-side electronic value in a state in which the balance is associated with terminal identification information by which a money terminal is identified; a reference amount acquiring function of acquiring, from the money terminal, a reference amount of the balance of server-side electronic value, the reference amount stored in the money terminal, after determination is made by the determining function that immediate connection is possible; a notifying function of notifying the information processing server of the payment amount in a state in which the payment amount is associated with the terminal identification information of the money terminal, such that the balance of server-side electronic value stored in the balance storing means is reduced by the payment amount before new payment processing is started if the payment amount is less than or equal to the reference amount; and an outputting function of outputting information indicating completion of payment processing with the money terminal, the payment processing related to the payment amount, without waiting for a response to the notification made by the notifying function if the payment amount is less than or equal to the reference amount.

### Effect of the Invention

According to the present invention, it is possible to release the user from the procedure for using electronic money in a time which is nearly equal to the time of a stored value-type electronic money system also in a system of server-type electronic money.

### BRIEF DESCRIPTION OF DRAWINGS

FIG. 1 is a diagram for explaining the network configuration of an electronic money system according to a first embodiment;

FIG. 2 is a diagram for explaining the hardware configuration of a portable terminal;

FIG. 3 is a diagram for explaining the function of the portable terminal;

FIG. 4 is a diagram for explaining the configuration of an electronic money server;

FIG. 5 is a diagram for explaining databases of the electronic money server;

FIG. 6 is a diagram for explaining the configuration of a payment terminal;

FIG. 7 is a flowchart of the processing procedure of each embodiment;

FIG. 8 is a flowchart of the processing procedure of the first embodiment;

FIG. 9 is a flowchart of the processing procedure of a second embodiment;

FIG. 10 is a flowchart of the processing procedure of a third embodiment;

FIG. 11 is a diagram depicting processing to update a mirror value of a server-side value balance of the portable terminal by using a push communication distribution server;

FIG. 12 is a diagram for explaining an electronic money system of Existing Example 1;

FIG. 13 is a flowchart of the processing procedure of Existing Example 1; and

FIG. 14 is a flowchart of the processing procedure of Existing Example 2.

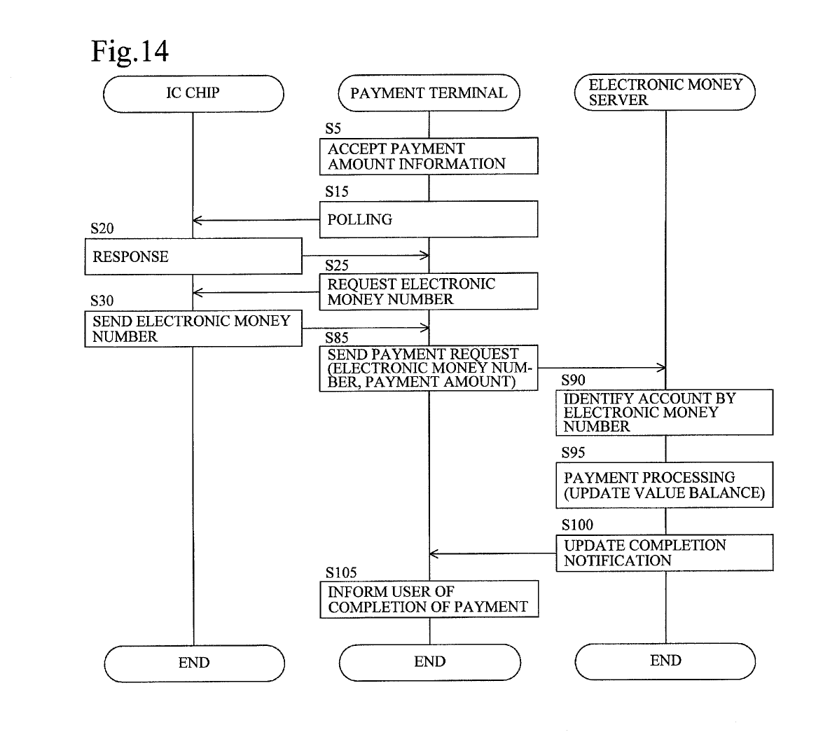

### DESCRIPTION OF EMBODIMENTS

### (1) Outline of an Embodiment

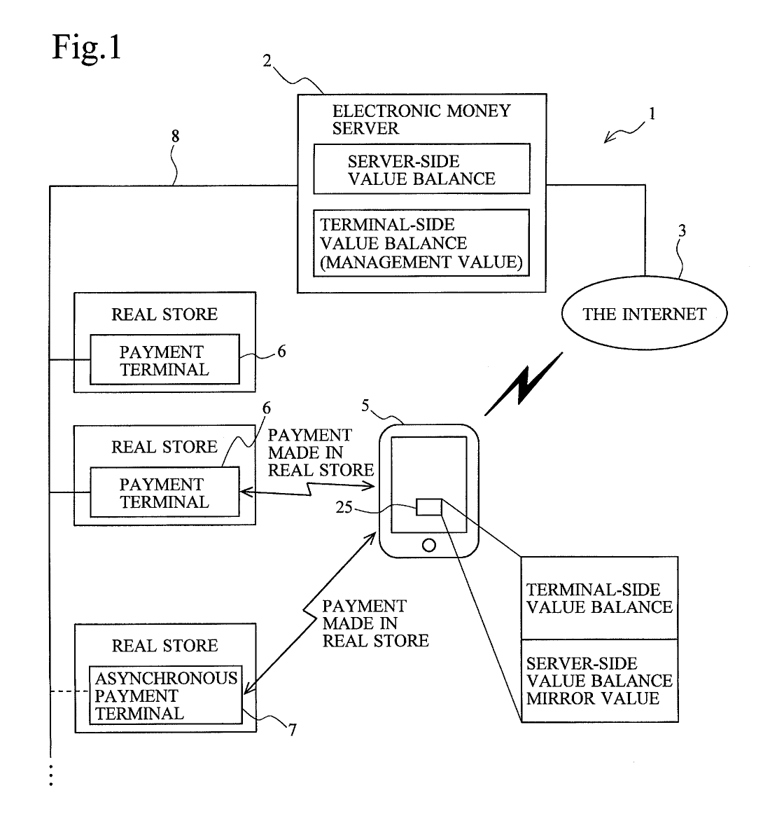

A portable terminal 5 (FIG. 1) stores a terminal-side value balance and a mirror value of a server-side value balance in the portable terminal. The mirror value of the server-side value balance is a reference value reflecting fluctuations in the server-side value balance managed by an electronic money server 2. It is preferable that this value is always synchronized with the server-side value balance in real time, but this is not necessarily required.

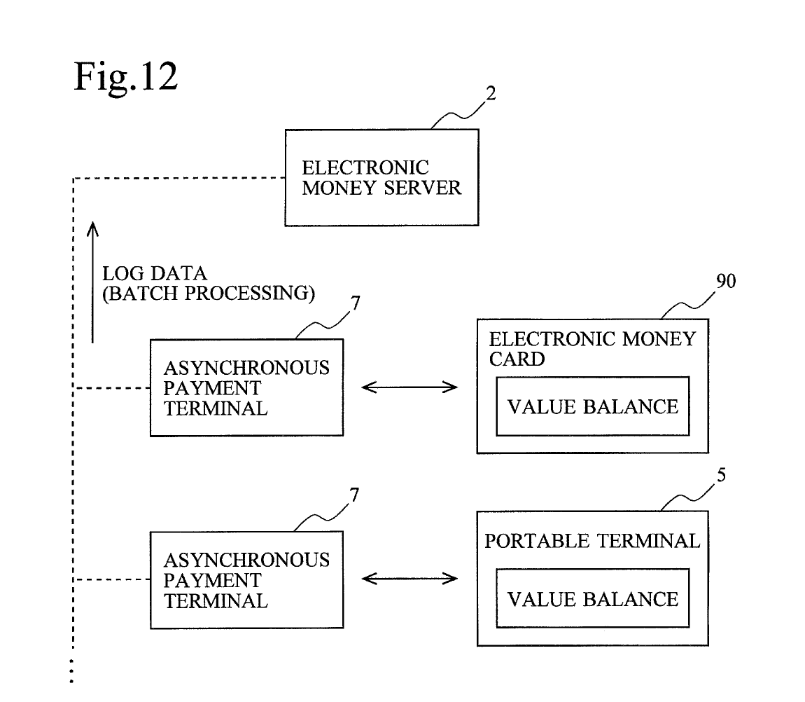

The electronic money server 2 stores the server-side value balance. When payment is made, the electronic money server 2 updates the value balance in synchronization with the payment. The electronic money server 2 also stores the terminal-side value balance in a state in which the terminal-side value balance is related to the server-side value balance. The stored terminal-side value balance is updated as a result of the electronic money server 2 receiving log data by batch processing as depicted in FIG. 12.

The electronic money server 2 sets the order of priority of a value balance which is used for payment in the order of the server-side value balance and the terminal-side value balance.

Then, if payment can be made by using the server-side value balance, the electronic money server 2 makes payment by using the server-side value balance; if the server-side value balance is not enough and there is a shortfall, the electronic money server 2 subtracts an amount corresponding to the shortfall from the terminal-side value balance.

In a first embodiment, when payment is made by using the server-side value balance, after a payment terminal 6 updates the mirror value of the server-side value balance stored in the portable terminal 5, the electronic money server 2 updates the server-side value balance.

In a second embodiment, if the server-side value balance is not enough and there is a shortfall, the payment terminal 6 makes payment of an amount corresponding to the shortfall from the terminal-side value balance.

In a third embodiment, when payment is made by using the server-side value balance, after updating the server-side value balance, the electronic money server 2 reflects the fluctuations in the server-side value balance in the mirror value of the server-side value balance stored in the portable terminal 5 without the payment terminal 6.

### (2) Details of the First Embodiment

FIG. 1 is a diagram for explaining the network configuration of an electronic money system 1 according to the first embodiment.

The electronic money system 1 is configured by using the electronic money server 2, the Internet 3, the portable terminal 5, the payment terminal 6, an asynchronous payment terminal 7, a communication line 8, and so forth.

The electronic money server 2 is a server that manages the transfer of money value by value. Here, value is electronic information related to money value, and the electronic money system 1 transfers money value by increasing or decreasing the balance of value (hereinafter, a value balance).

In addition, a business entity of the electronic money system 1 relates the transfer of value to the transfer of actual money by transferring actual money in response to the transfer of value.

The electronic money server 2 stores a value balance in a state in which the value balance is related to the portable terminal 5. As will be described later, the portable terminal 5 stores a value balance also in the portable terminal 5, and, to distinguish between these value balances, the value balance stored on the side of the electronic money server 2 will be referred to as a “server-side value balance” and the value balance stored by the portable terminal 5 will be referred to as a “terminal-side value balance”. The electronic money server 2 also stores a management value of the terminal-side value balance for management.

As described above, in the electronic money system 1, a server management-type system based on the server-side value balance and a stored value-type system based on the terminal-side value balance coexist.

Then, when accepting a payment request from the payment terminal 6, the electronic money server 2 first makes payment by using the server-side value balance, and, if there is a shortfall, the electronic money server 2 makes payment of an amount corresponding to the shortfall from the terminal-side value balance of the portable terminal 5.

The portable terminal 5 is a portable terminal formed as, for example, a smartphone, a mobile telephone, a game console, a tablet computer, or the like and has the function of connecting to the Internet 3 and the function of connecting to the payment terminal 6 and the asynchronous payment terminal 7 by short-distance radio communication.

The portable terminal 5 has a built-in general-purpose IC chip 25 and stores the terminal-side value balance and the mirror value of the server-side value balance therein.

The payment terminal 6 performs short-distance radio communication with the portable terminal 5 and performs communication also with the electronic money server 2 via the communication line 8, thereby sending information such as a payment amount to the electronic money server 2 and relaying the communication between the electronic money server 2 and the portable terminal 5. The payment terminal 6 is a synchronous payment terminal that performs online communication with the electronic money server 2 in real time at the time of payment using the portable terminal 5.

The payment terminal 6 is installed in an accounting counter, an automatic vending machine, or the like of a real store (a real store that is physically open in a real existing store or the like) such as a convenience store.

The communication line 8 is a line that connects the electronic money server 2 with the payment terminal 6. As the communication line 8, a dedicated line can be used, and a general-purpose line such as the Internet 3 may also be used.

The asynchronous payment terminal 7 is installed in, for example, a store and an automatic vending machine with inconvenient network equipment and has the function of performing short-distance radio communication with the portable terminal 5.

The asynchronous payment terminal 7 makes payment by using the terminal-side value balance by performing short-distance radio communication with the portable terminal 5. The asynchronous payment terminal 7 is usually not connected to the electronic money server 2 (therefore cannot make real-time payment by using the server-side value balance) and temporarily stores the details of payment performed between the asynchronous payment terminal 7 and the portable terminal 5 as log data.

Then, the asynchronous payment terminal 7 connects to the electronic money server 2 around once a day by using the communication line 8 and sends the log data to the electronic money server 2. In an environment with no network communication equipment, a person in charge sometimes manually collects a recording medium on which the log data is recorded.

As for the terminal-side value balance, the electronic money server 2 manages the fund transfer based on the log data in the payment terminal 6 and the asynchronous payment terminal 7.

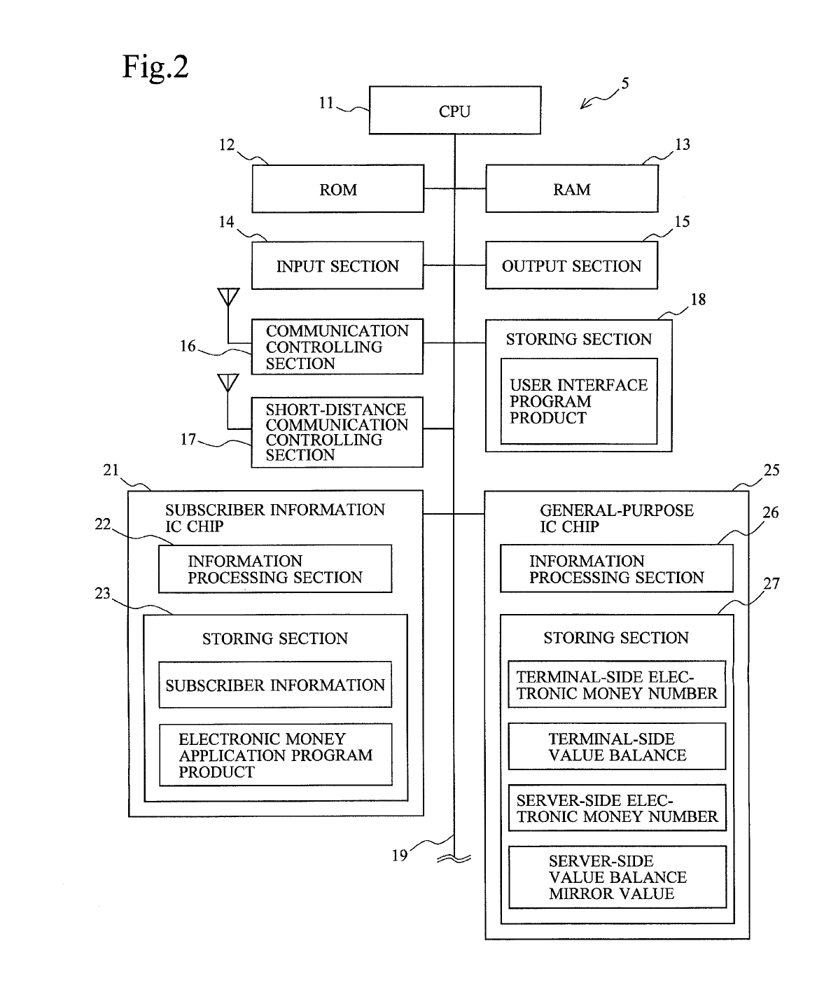

FIG. 2 is a diagram depicting the hardware configuration of the portable terminal 2. Here, as an example, it is assumed that the portable terminal 5 is a smartphone, but the same goes for a mobile telephone and other portable terminals.

The portable terminal 5 is formed of a CPU (Central Processing Unit) 11, ROM (Read Only Memory) 12, RAM (Random Access Memory) 13, an input section 14, an output section 15, a communication controlling section 16, a short-distance communication controlling section 17, a storing section 18, a subscriber information IC chip 21, the general-purpose IC chip 25, and so forth which are connected to one another by a bus line 19.

The CPU 11 performs various kinds of information processing and overall control of the portable terminal 5 by executing a program product recorded on the ROM 12 and the storing section 18. In this embodiment, for example, the CPU 11 supports payment processing using the server-side value balance and the terminal-side value balance by cooperating with the electronic money server 2 by the function provided by an electronic money application program product which will be described later.

The ROM 12 is read-only memory, and a basic program product used by the portable terminal 5 to operate, a parameter, data, and so forth are recorded thereon.

The RAM 13 is readable/writable memory and offers working memory used when the CPU 11 performs information processing.

The output section 15 is a functional section that outputs information to the user and is provided with a liquid crystal display for screen display, a speaker from which sound is output, and so forth. On the liquid crystal display, for example, an icon for starting the electronic money application program product is displayed.

The input section 14 is a functional section that inputs information from the outside and is provided with a touch panel installed on the liquid crystal display, a microphone that inputs sound, a camera that takes an image of a subject, and so forth. By touching the touch panel in response to the display on the liquid crystal display, the user can enter information.

The storing section 18 is formed by using, for example, a recording medium such as an EEPROM (Electrically Erasable and Programmable ROM) and a hard disk, and an OS (Operating System) which is a basic program product that controls the portable terminal 5, a user interface program product that implements a user interface, and other program products and data are recorded thereon.

The communication controlling section 16 includes an antenna for performing radio communication with a base station antenna of a mobile telephone network and connects the portable terminal 5 to the Internet 3 or a telephone line. The portable terminal 5 can perform communication with the electronic money server 2 through the communication controlling section 16 via the Internet 3.

The short-distance communication controlling section 17 includes an antenna for performing short-distance radio communication with reader/writers of the payment terminal 6 and the asynchronous payment terminal 7 and connects the subscriber information IC chip 21 and the general-purpose IC chip 25 to the payment terminal 6 and the asynchronous payment terminal 7. In addition to performing communication with the payment terminal 6 via the short-distance communication controlling section 17, the subscriber information IC chip 21 and the general-purpose IC chip 25 can perform communication with the electronic money server 2 via the portable terminal 5.

The subscriber information IC chip 21 is an IC chip that stores telephone subscriber information and is mounted on the portable terminal 5 as an IC card that can be attached to and detached from the portable terminal 5. This card is called a SIM (Subscriber Identity Module) card, for example.

The subscriber information IC chip 21 is formed of a CPU, RAM, ROM, and so forth and is provided with an information processing section 22 that performs information processing in accordance with various program products and a storing section 23 formed of nonvolatile memory.

In the storing section 23, subscriber information, the electronic money application program product, and so forth are stored. This electronic money application program product may be stored in the storing section 18.

The telephone subscriber information includes ID information by which a telephone number is identified, and the portable terminal 5 to which the subscriber information IC chip 21 is attached becomes a functioning portable terminal by this telephone number.

The electronic money application program product is a program product that supports payment by value and is expanded on the RAM 13 and is executed by the CPU 11.

As described above, since the subscriber information IC chip 21 stores the electronic money application program product in addition to the subscriber information, when, for example, the user buys a new model to replace the portable terminal 5 with it, the user can continuously use the electronic money service in addition to the telephone number by attaching the subscriber information IC chip 21 to the new portable terminal 5.

In addition to this, in the storing section 23, authentication data used by the electronic money server 2 to authenticate the subscriber information IC chip 21 can also be stored.

The general-purpose IC chip 25 is an IC chip that stores a general-purpose application and is incorporated into the portable terminal 5. The user can download an application and stores the application in the general-purpose IC chip 25.

The general-purpose IC chip 25 is formed of a CPU, RAM, ROM, and so forth and is provided with an information processing section 26 that performs information processing in accordance with various program products and a storing section 27 formed of non-volatile memory.

In the storing section 27, a terminal-side electronic money number and the terminal-side value balance, a server-side electronic money number and a mirror value of the server-side value balance, and, though not depicted in the drawing, a value operation program product used by the information processing section 26 to operate the terminal-side value balance and the mirror value of the server-side value balance, authentication data used by the electronic money server 2 to authenticate the general-purpose IC chip 25, and so forth are stored.

The terminal-side electronic money number is an account number used by the electronic money server 2 to identify the user of the terminal-side value balance. The server-side electronic money number is an account number used by the electronic money server 2 to identify an account which is a unit of management of the server-side value balance.

Payment processing and increase processing related to the terminal-side value balance and the mirror value of the server-side value balance in the general-purpose IC chip 25 are performed by the value operation program product formed in the information processing section 26 in the general-purpose IC chip 25 in accordance with an instruction from the outside in order to increase security by limiting processing of the terminal-side value balance and the mirror value of the server-side value balance to the inside of the general-purpose IC chip 25.

Incidentally, as for processing of the value balance, information to be input to the subscriber information IC chip 21 and the general-purpose IC chip 25 is encrypted and is decoded in the subscriber information IC chip 21 and the general-purpose IC chip 25, and the information to be output from the subscriber information IC chip 21 and the general-purpose IC chip 25 is output after being encrypted in these chips.

Here, an example in which the server-side electronic money number and the mirror value of the server-side value balance are stored in the storing section 27 of the general-purpose IC chip 25 has been described; for example, the server-side electronic money number and the mirror value of the server-side value balance may be stored in the storing section 23 of the subscriber information IC chip 21. Moreover, another general-purpose IC chip may be provided and the server-side electronic money number and the mirror value of the server-side value balance may be stored therein.

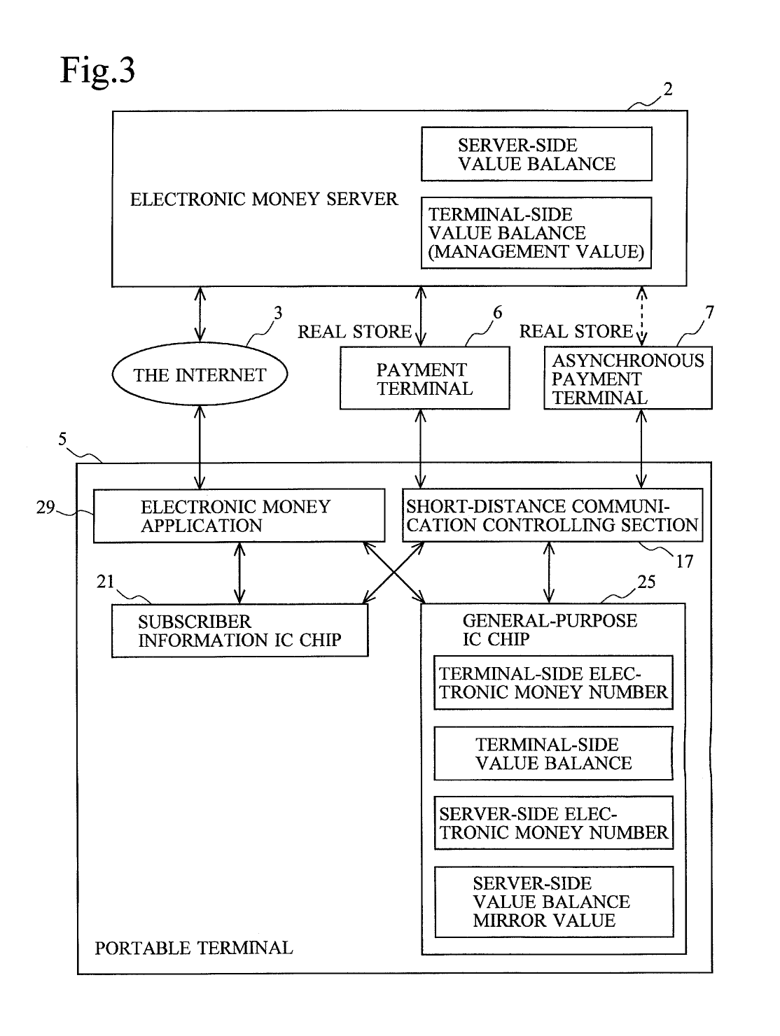

FIG. 3 is a diagram for explaining the function of the portable terminal 5.

When the electronic money application program product is executed, an electronic money application 29 is formed in the portable terminal 5.

In the case of payment in a real store provided with the payment terminal 6, the short-distance communication controlling section 17 performs communication with the payment terminal 6.

In the case of payment in a real store provided with the asynchronous payment terminal 7, the short-distance communication controlling section 17 performs communication with the asynchronous payment terminal 7.

Moreover, the electronic money application 29 can access the subscriber information IC chip 21 and the general-purpose IC chip 25.

In the case of payment in a real store, the short-distance communication controlling section 17 can increase or decrease the terminal-side value balance or the mirror value of the server-side value balance and read the server-side electronic money number and the terminal-side electronic money number by operating the value operation program product in the general-purpose IC chip 25.

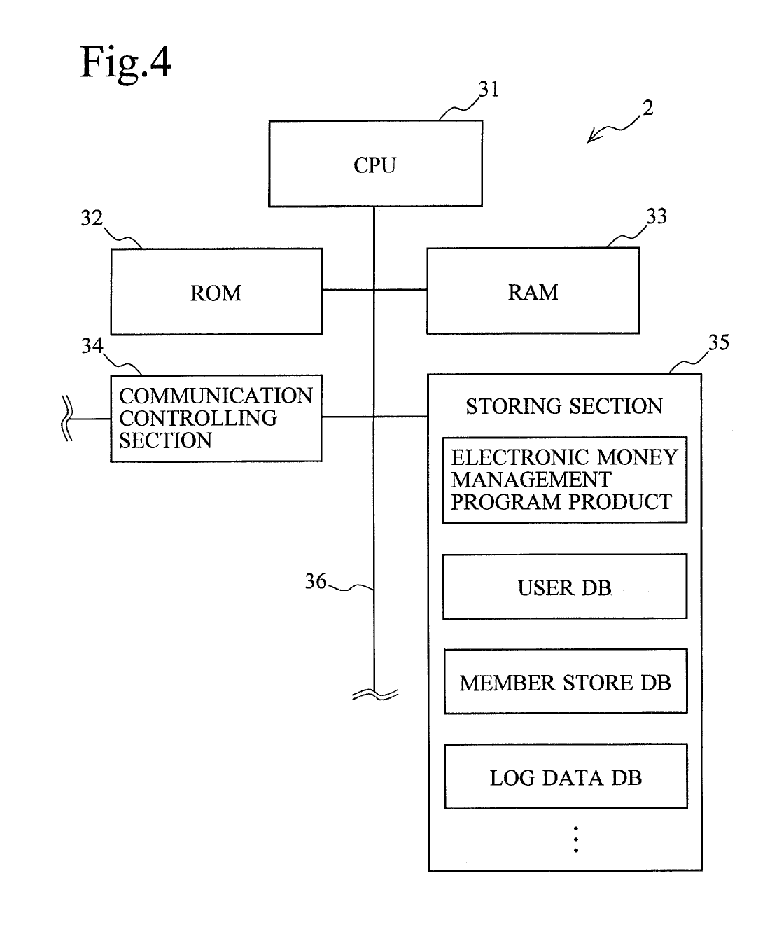

FIG. 4 is a diagram for explaining the configuration of the electronic money server 2.

The electronic money server 2 is formed of a CPU 31, ROM 32, RAM 33, a communication controlling section 34, a storing section 35, and so forth which are connected to one another via a bus line 36.

The CPU 31 performs various kinds of information processing and overall control of the electronic money server 2 by executing the program product stored in the ROM 32 and the storing section 35.

In this embodiment, the CPU 31 performs payment processing by value by updating the server-side value balance and the terminal-side value balance in real time while performing communication with the payment terminal 6, the asynchronous payment terminal 7, and the portable terminal 5.

Incidentally, as for payment with the asynchronous payment terminal 7, the electronic money server 2 processes the payment by receiving, from the asynchronous payment terminal 7 at a later time, the log data of the update of the terminal-side value balance performed by the asynchronous payment terminal 7.

The ROM 32 is read-only memory, and a basic program product used by the electronic money server 2 to operate, a parameter, data, and so forth are recorded thereon.

The RAM 33 is readable/writable memory and offers working memory used when the CPU 31 performs information processing.

With the communication controlling section 34, the electronic money server 2 performs communication with the payment terminal 6, the asynchronous payment terminal 7, and the portable terminal 5 via the communication line 8 and performs communication with the portable terminal 5 via the Internet 3.

The storing section 35 is formed of, for example, a large-capacity hard disk, and an electronic money management program product and other program products which are used by the CPU 31 to perform payment processing by value, a user DB (database) managing a user's server-side value balance and terminal-side value balance, a member store DB managing value payment performed in a member store, a log data DB storing log data of each payment processing, and so forth are recorded thereon.

Incidentally, in this example of FIG. 4, a single electronic money server 2 has been described, but this electronic money server 2 may be formed of a plurality of servers by distributing the function.

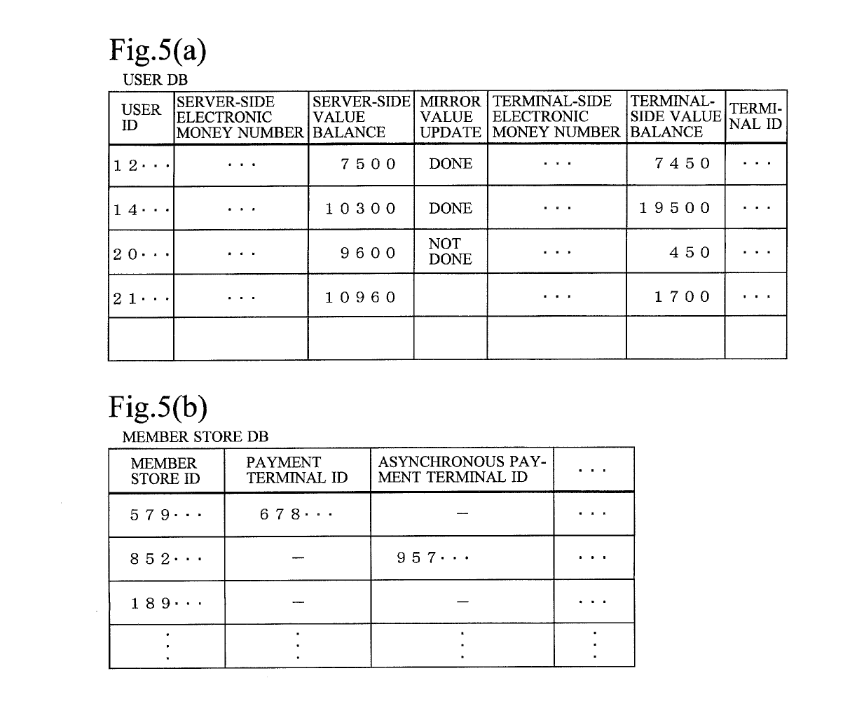

Next, by using the drawings of FIG. 5, the databases of the electronic money server 2 will be explained.

FIG. 5(a) is a diagram for explaining the logical configuration of the user D13.

In this embodiment, the server-side electronic money number and the terminal-side electronic money number are stored in a state in which the server-side electronic money number and the terminal-side electronic money number are related to a user ID. Though not depicted in the drawing, items such as the authentication data of the general-purpose IC chip 25 are also stored.

The item “user ID” is user identification information. The item “server-side electronic money number” is an account number for distinguishing a server-side value balance from the server-side value balances of other users.

The item “server-side value balance” is a server-side value balance of the account identified by the item “server-side electronic money number”.

The item “mirror value update” is a field indicating the record as to whether the mirror value of the server-side value balance stored in the portable terminal 5 has been updated or not. If update has been performed, “done” is recorded thereon; if update has not been performed, “not done” is recorded thereon.

The item “terminal-side electronic money number” is an account number for distinguishing a terminal-side value balance from the terminal-side value balances of other users.

The item “terminal-side value balance” is a management value of the terminal-side value balance of the account identified by the item “terminal-side electronic money number”. This value balance can also be updated by receiving the log data by batch processing.

The item “terminal ID” is an ID by which the portable terminal is identified, the ID given by a push communication distribution server which will be described later.

Incidentally, the “server-side electronic money number” and the “terminal-side electronic money number” may be managed by the same number.

FIG. 5(b) is a diagram for explaining the logical configuration of the member store DB.

The member store DB is formed of “member store ID”, “payment terminal ID”, “asynchronous payment terminal ID”, and other items.

The item “member store ID” is information for identifying a business operator who gets payment service by electronic money, the payment service offered by the electronic money system 1.

The item “payment terminal ID” is information for identifying the payment terminal 6 of the member store.

The item “asynchronous payment terminal ID” is information for identifying the asynchronous payment terminal 7 of the member store.

Incidentally, if the member store is a virtual store, since the member store does not have the payment terminal 6 and the asynchronous payment terminal 7, in place of these terminal IDs, for example, information by which a virtual store server is identified, such as the IP address of the virtual store server, is used.

The payment terminal 6 and the asynchronous payment terminal 7 notify the electronic money server 2 of the payment terminal ID or the like thereof when connecting thereto. As a result, the electronic money server 2 can identify the member store ID of the member store related to the fund transfer.

Incidentally, since a business operator generally installs a plurality of payment terminals in one store, a plurality of payment terminal IDs and a plurality of asynchronous payment terminal IDs are generally related to one member store ID.

Moreover, since the payment amount of a commercial transaction performed in the member store is recorded on the log data in a state in which the payment amount is related to the member store ID, the member store ID functions as an account number of the member store.

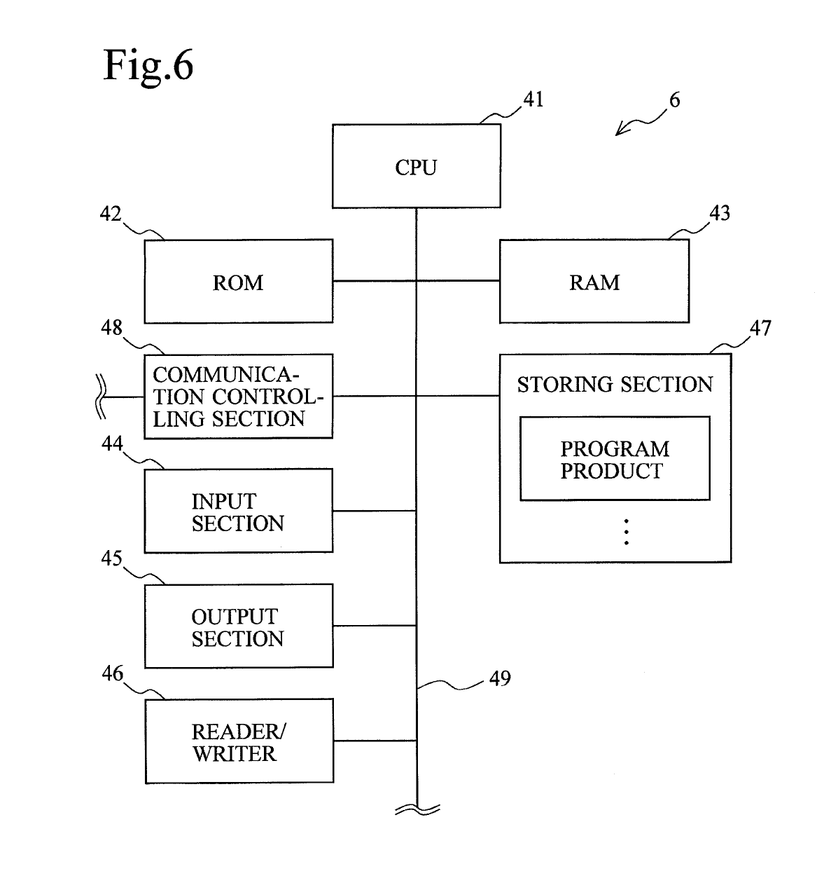

FIG. 6 is a diagram for explaining the configuration of the payment terminal 6.

The payment terminal 6 is formed of a CPU 41, ROM 42, RAM 43, an input section 44, an output section 45, a reader/writer 46, a storing section 47, and a communication controlling section 48 which are connected to one another via a bus line 49.

The CPU 41 performs various kinds of information processing and overall control of the payment terminal 6 by executing the program product recorded on the ROM 42 and the storing section 47.

In this embodiment, the CPU 41 mediates communication between the portable terminal 5 and the electronic money server 2 and supports payment processing using the server-side value balance and the terminal-side value balance.

The ROM 42 is read-only memory, and a basic program product used by the payment terminal 6 to operate, a parameter, data, and so forth are recorded thereon.

The RAM 43 is readable/writable memory and offers working memory used when the CPU 41 performs information processing.

The input section 44 is provided with, for example, input devices such as a touch panel installed on the liquid crystal display and a keyboard and accepts, for example, entry of a payment amount.

The output section 45 is provided with a liquid crystal display for displaying an image for touch panel input, a speaker from which sound such as sound effect at the time of completion of payment is output, and so forth.

The reader/writer 46 performs short-distance radio communication with the portable terminal 5 by using a built-in antenna. Moreover, the reader/writer 46 is provided with an LED and can inform the user of the completion of payment by flashing or the like at the time of completion of payment based on a control signal from the payment terminal 6.

On the storing section 47, for example, a program product for making the CPU 41 fulfill the function of performing payment processing with the electronic money server 2 is recorded.

The communication controlling section 48 connects the electronic money server 2 and the payment terminal 6 via the communication line 8. This connection is performed at all times; instead, this connection may be established every time payment processing is performed.

The asynchronous payment terminal 7 includes, in addition to the component elements of the payment terminal 6, a secure module (not depicted in the drawing) that stores key data used for encryption and decoding of data.

This secure module may be provided in the payment terminal 6.

The asynchronous payment terminal 7 completes payment processing locally by using the terminal-side value balance of the portable terminal 5 and sends the log data to the electronic money server 2 at regular or irregular intervals by the communication controlling section 48.

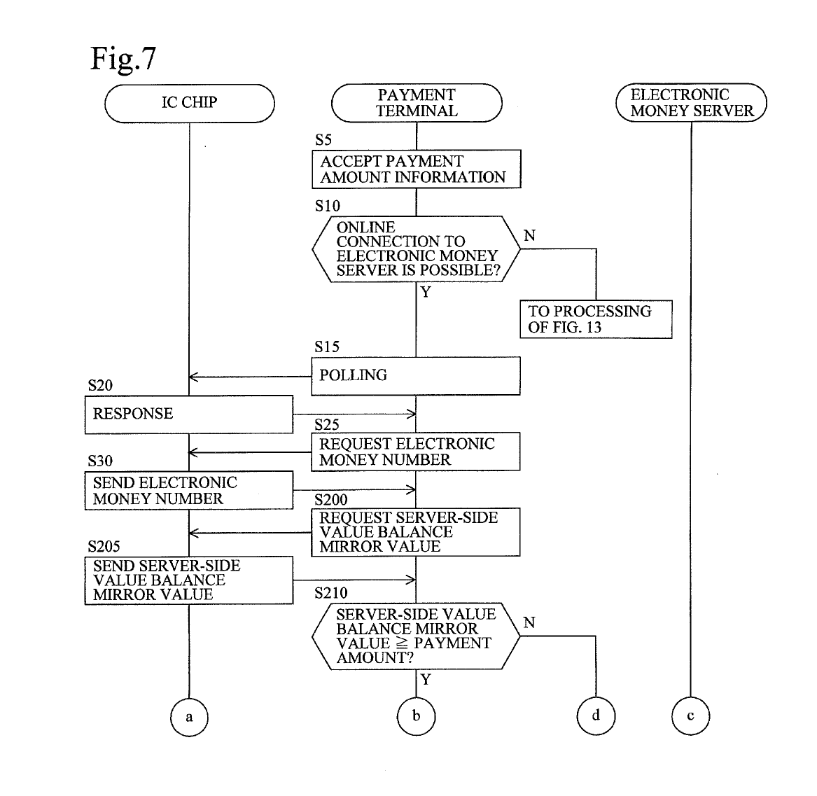

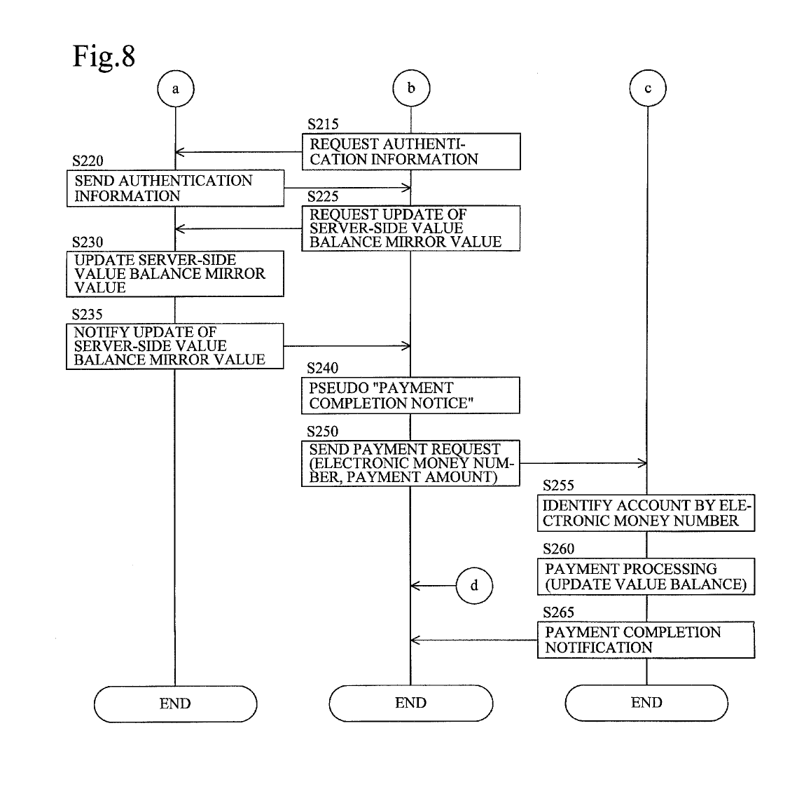

FIGS. 7 and 8 are flowcharts depicting the processing procedure according to the first embodiment.

Incidentally, it is assumed that the user sets, on the payment terminal 6, the portable terminal 5 on which value used for payment is recorded with appropriate timing such as being urged by a store clerk. Next, the payment terminal 6 accepts entry of payment amount information from an employee of a store, for example (step 5). Here, the payment terminal 6 determines whether or not online connection to the electronic money server 2 is possible (step 10).

Here, being online connectable refers to a state in which the payment terminal 6 can connect to the electronic money server 2 immediately, preferably, a state in which the payment terminal 6 can transmit information immediately to the electronic money server 2 online. Specifically, it refers to a state in which the payment terminal 6 is connected in a state in which the payment terminal 6 can transmit information to the electronic money server 2 via a network such as the Internet 3 or the communication line 8 and it is within a predetermined time from the start of this connection.

Moreover, in this determination made in step 10, it may also be determined whether or not it is within a predetermined time from the previous (last) information transmission from the payment terminal 6 to the electronic money server 2.

Furthermore, if a token is sent from the payment terminal 6 to the electronic money server 2 at regular intervals in a vacant time, it is determined whether or not it is within a predetermined time from a point of time at which the last response was received.

Moreover, in this determination made in step 10, it may also be determined whether or not it is within a predetermined time from the previous (last) information transmission from the electronic money server 2 to the payment terminal 6.

Furthermore, if the electronic money server 2 performs polling on the payment terminal 6 at regular intervals, it is determined whether or not it is within a predetermined time from a point of time at which the last polling was performed.

In determination made in step 10, when a plurality of payment terminals 6 are installed in the same store, if the payment terminal 6 is not a higher-order payment terminal, it is also determined whether or not the payment terminal 6 connects to a payment terminal 6 (a higher-order payment terminal) connecting to the electronic money server 2 via the network.

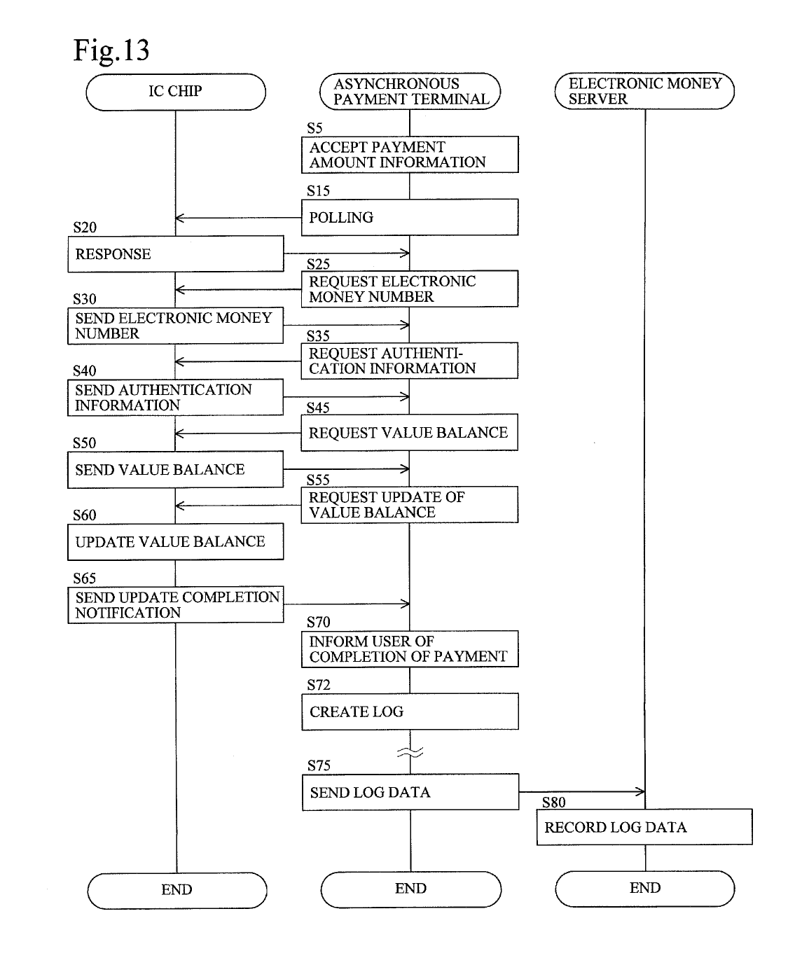

If it is determined that, in determination made in step 10, online connection to the electronic money server 2 is not possible (step 10; N), the procedure transitions to processing of stored value-type electronic money using the existing asynchronous payment terminal depicted in FIG. 13.

On the other hand, if it is determined that, in determination made in step 10, online connection to the electronic money server 2 is possible (step 10; Y), the payment terminal 6 performs polling on the general-purpose IC chip 25 of the portable terminal 5 on which value used for payment is recorded (step 15).

In response to this, the general-purpose IC chip 25 returns a response to the payment terminal 6 (step 20). At that time, the general-purpose IC chip 25 sends the IC chip ID thereof to the payment terminal 6.

When receiving the response from the general-purpose IC chip 25, the payment terminal 6 requests an electronic money number from the general-purpose IC chip 25 (step 25). The electronic money number is information by which the general-purpose IC chip 25 is identified in the electronic money server 2.

When there is a request for the electronic money number from the payment terminal 6, the general-purpose IC chip 25 sends the electronic money number to the payment terminal 6 (step 30).

Then, the payment terminal 6 requests a server-side value balance mirror value from the general-purpose IC chip 25 (step 200). The general-purpose IC chip 25 sends the server-side value balance mirror value stored therein to the payment terminal 6 (step 205).

The payment terminal 6 which has received the server-side value balance mirror value compares the payment amount received instep 5 with this server-side value balance mirror value (step 210). As a result, if the payment amount is greater than the server-side value balance mirror value (step 210; N), the payment terminal 6 cannot make payment and therefore ends the processing.

On the other hand, if the server-side value balance mirror value is equal to or greater than the payment amount received in step 5 and payment is possible (step 210; Y), the payment terminal 6 requests the authentication information from the general-purpose IC chip 25 (step 215). In response to this, the general-purpose IC chip 25 sends the authentication information to the payment terminal 6 (step 220).

The payment terminal 6 receives the authentication information from the general-purpose IC chip 25 and authenticates the general-purpose IC chip, and requests the general-purpose IC chip 25 to update the server-side value balance mirror value (step 225).

Incidentally, the processing in step 215 and step 220 which is related to authentication may be performed in advance such as after step 30 or after step 205.

Having received the request to update the server-side value balance mirror value, the general-purpose IC chip 25 updates the server-side value balance mirror value (step 230). That is, the general-purpose IC chip 25 reduces the server-side value balance mirror value by the payment amount.

The general-purpose IC chip 25 notifies the payment terminal 6 of the update of the server-side value′balance mirror value (step 235).

Here, the payment terminal 6 gives a pseudo “payment completion notice” (step 240) and informs the user (the owner of the portable terminal 5 incorporating the general-purpose IC chip 25) of the completion of payment. The payment terminal 6 performs this processing without waiting for a notification in step 265 which will be described later. As a mode of notice, for example, a payment completion sound may be produced or the LED of the reader/writer 46 may be made to flash.

As a result of such processing, the user can feel that, while using the server-side value, the processing has been completed in a processing time which is nearly equal to the processing time in a case where the existing stored value-type electronic money is used.

That is, this does not give the user a feeling of discomfort or strangeness caused by the longer processing time and does not increase the probability of the occurrence of an error because the processing is completed in a short time.

Then, the payment terminal 6 sends a payment request to the electronic money server 2 (step 250). This payment request includes the electronic money number acquired from the general-purpose IC chip 25 and the payment amount. This processing may be performed after it is confirmed that the server-side value balance mirror value is equal to or greater than the payment amount received in step 5 and payment is possible (step 210; Y) and before new payment processing is performed. Such processing is possible because it has been determined in step 10 that online connection to the electronic money server 2 is possible.

The electronic money server 2 identifies an account that manages the value of electronic money associated with the IC chip (step 255). Then, the electronic money server 2 performs payment processing by updating the value balance recorded on the account (step 260).

Then, the electronic money server 2 sends a payment completion notification to the payment terminal 6 (step 265).

In the first embodiment, processing between the payment terminal 6 and the general-purpose IC chip 25 and processing (communication) between the payment terminal 6 and the electronic money server 2 are separated from each other, and, when the former is completed, the user is informed of the completion of payment in a pseudo manner.

As a result, according to this first embodiment, the user can complete the processing as if the user used the existing stored value-type electronic money. Moreover, since the server-side value balance is also updated without delay after the server-side value balance mirror value is updated, an inconvenience which might be caused by a difference between them is not caused.

Therefore, when the user tries to make another payment with another payment terminal immediately after the payment, the server-side value balance too has already been updated.

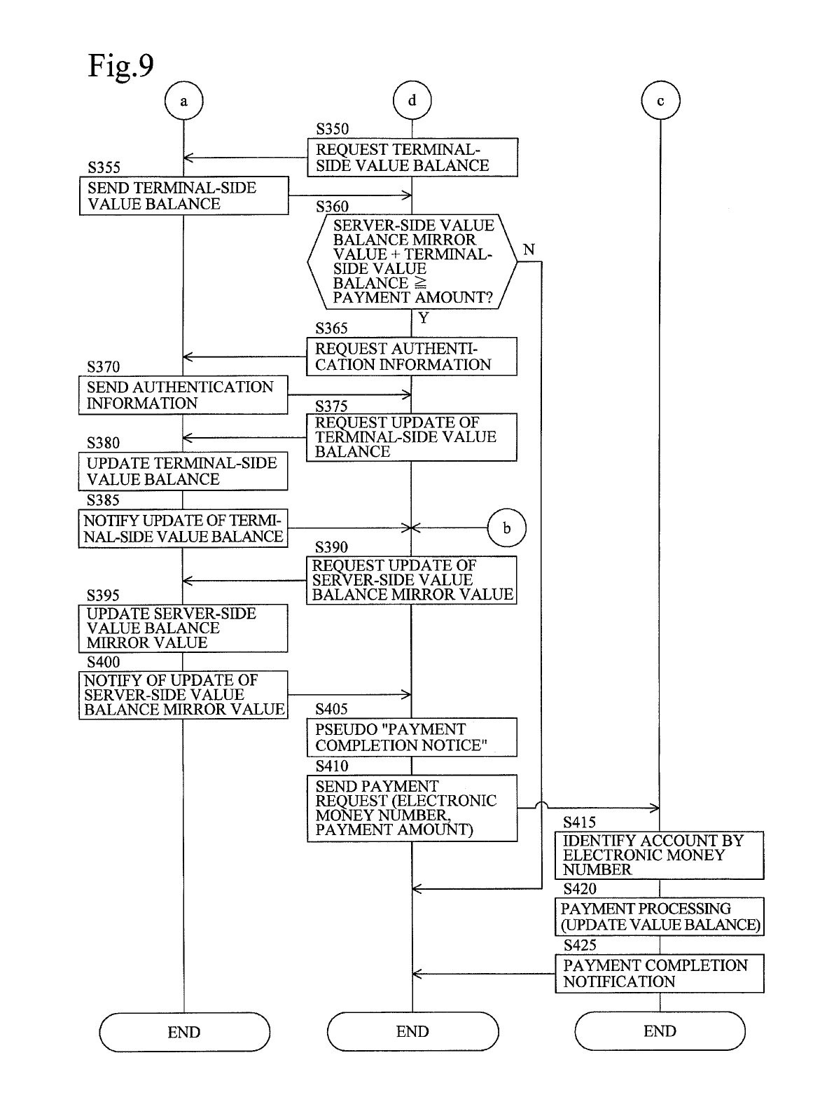

Next, with reference to FIGs. 7 and 9, the second embodiment will be described.

In this second embodiment, processing from step 5 to step 210 depicted in FIG. 7 is the same as the processing of the first embodiment. Therefore, the explanation thereof is omitted here.

In step 210, the payment terminal 6 which has received the server-side value balance mirror value compares the payment amount received in step 5 with the server-side value balance mirror value. As a result, if the payment amount is greater than the server-side value balance mirror value (step 210; N), payment is not possible; therefore, the payment terminal 6 further requests the terminal-side value balance from the general-purpose IC chip 25 (step 350). In response to this request, the general-purpose IC chip 25 sends the terminal-side value balance to the payment terminal 6 (step 355).

Incidentally, if, in step 210, the server-side value balance mirror value is equal to or greater than the payment amount received in step 5 and payment is possible (step 210; Y), the procedure proceeds to step 390 and processing similar to that of the first embodiment is performed.

Then, the payment terminal 6 compares an amount obtained by adding the server-side value balance mirror value to the terminal-side value balance and the payment amount to determine which is greater than the other (step 360).

As a result, if the payment amount is still greater than the amount obtained by addition, payment is not possible and therefore the payment terminal 6 ends the processing (step 360; N).

On the other hand, if the amount obtained by adding the server-side value balance mirror value and the terminal-side value balance is equal to or greater than the payment amount (step 360; Y), payment is possible and the payment terminal 6 makes payment by using them.

Specifically, the payment terminal 6 uses up the server-side value balance and makes payment of an amount corresponding to the shortfall by using the terminal-side value balance. Incidentally, if the payment terminal 6 can make payment by using the terminal-side value balance, the payment terminal 6 may cover an amount corresponding to a shortfall by the server-side value balance if there is a shortfall.

Moreover, a given threshold value may be provided in the server-side value balance, and, if the server-side value balance falls below that value, the payment terminal 6 may make payment of an amount corresponding to a shortfall by using the terminal-side value balance.

Then, the payment terminal 6 requests the authentication information from the general-purpose IC chip 25 (step 365). In response to this, the general-purpose IC chip 25 sends the authentication information to the payment terminal 6 (step 370).

The payment terminal 6 receives the authentication information from the general-purpose IC chip 25 and authenticates the IC chip, and requests the general-purpose IC chip 25 to update the terminal-side value balance (step 375).

Incidentally, the processing in step 365 and step 370 which is related to authentication maybe performed in advance such as after step 30 or after step 205.

In response to the request to update the terminal-side value balance, the general-purpose IC chip 25 updates the terminal-side value balance (step 380).

As the terminal-side value balance update processing that is performed here, the following methods are possible.

(Method 1) A case where an overwriting instruction is sent as a terminal-side value balance update request.

In this case, the electronic money server 2 subtracts an amount corresponding to the shortfall from the terminal-side value balance received from the CPU of the general-purpose IC chip 25 of the portable terminal 5 and calculates the balance after subtraction. Then, the electronic money server 2 sends, as the terminal-side value balance update request, an overwriting instruction by which overwriting is performed on the balance after calculation. The CPU of the general-purpose IC chip 25 of the portable terminal 5 performs update by performing overwriting with the terminal-side value balance in accordance with the overwriting instruction.

(Method 2) A case where a subtraction instruction is sent as the terminal-side value balance update request.

In this case, the electronic money server 2 sends a subtraction instruction by which an amount corresponding to the shortfall is subtracted from the terminal-side value balance to the CPU of the general-purpose IC chip 25 of the portable terminal 5 as the terminal-side value balance update request. The CPU of the general-purpose IC chip 25 of the portable terminal 5 updates the terminal-side value balance by subtracting an amount corresponding to the shortfall from the terminal-side value balance in accordance with the instruction.

The general-purpose IC chip 25 notifies the payment terminal 6 of the update of the terminal-side value balance (step 385).

Then, the payment terminal 6 requests the general-purpose IC chip 25 to update the server-side value balance mirror value (step 390).

In response to the request to update the server-side value balance mirror value, the general-purpose IC chip 25 updates the server-side value balance mirror value (step 395).

The general-purpose IC chip 25 notifies the payment terminal 6 of the update of the server-side value balance mirror value (step 400).

In this example, in the general-purpose IC chip 25, after the terminal-side value balance is updated, the server-side value balance mirror value is updated; this processing may be reversed in such a way that, after the server-side value balance mirror value is updated, the terminal-side value balance is updated.

Here, the payment terminal 6 gives a pseudo “payment completion notice” (step 405) and informs the user (the owner of the portable terminal 5 incorporating the general-purpose IC chip 25) of the completion of payment. The payment terminal 6 performs this processing without waiting for a notification in step 265 which will be described later. As a mode of notice, for example, a payment completion sound may be produced or the LED of the reader/writer 46 may be made to flash.

As a result of such processing, as is the case with the first embodiment, the user can feel that, while using the server-side value, the processing has been completed in a processing time which is nearly equal to the processing time in a case where the existing stored value-type electronic money is used.

Then, the payment terminal 6 sends a payment request to the electronic money server 2 (step 410).

Processing from sending of this payment request (step 410) to payment completion notification (step 425) is the same as the processing from step 250 to step 265 of the first embodiment.

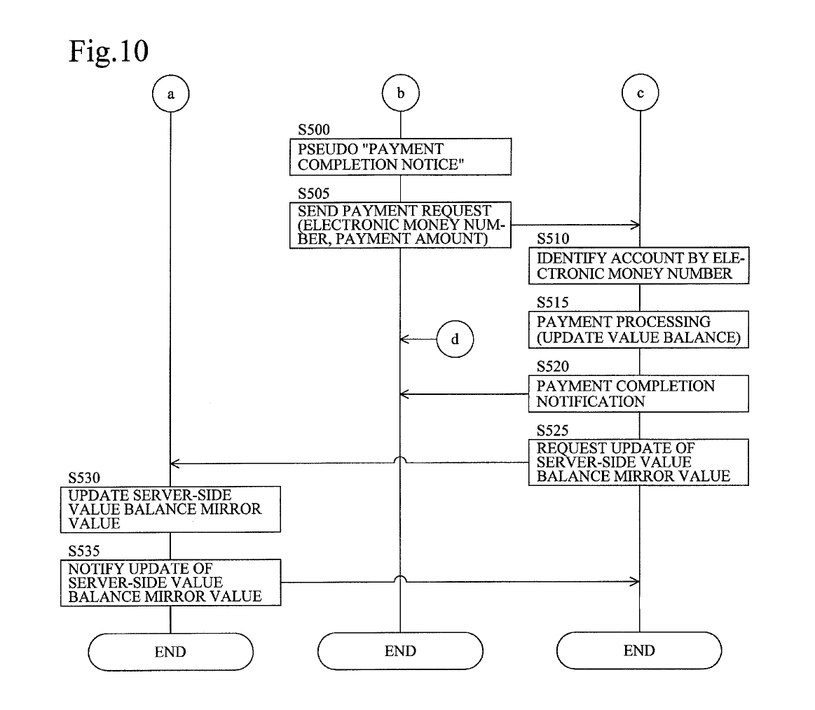

Next, with reference to FIGS. 7 and 10, the third embodiment will be described.

Processing from step 5 to step 210 depicted in FIG. 7 is the same as the processing of the first embodiment and the second embodiment.

Then, if the server-side value balance mirror value is equal to or greater than the payment amount received in step 5 and payment is possible in step 210 (step 210; Y), a pseudo “payment completion notice” is given (step 500) and a notice of the completion of payment is given.

As described above, in the third embodiment, a feature thereof is giving a pseudo “payment completion notice” without update of the server-side value balance mirror value, which is performed in the first embodiment. Then, the update of the server-side value balance mirror value is performed by communication between the electronic money server 2 and the portable terminal 5 later without the payment terminal 6.

The processing of sending of a payment request (step 505), identification of an account by an electronic money number (step 510), payment processing (value balance update) (step 515), and payment completion notification (step 520) is the same processing as the processing from step 250 to step 265 of the first embodiment and the processing from step 410 to step 425 of the second embodiment.

Then, the electronic money server 2 requests the general-purpose IC chip 25 incorporated into the portable terminal 5 to update the server-side value balance mirror value (step 525).

In response to this, the general-purpose IC chip 25 updates the server-side value balance mirror value (step 530). Then, the general-purpose IC chip 25 notifies the electronic money server 2 of the update of the server-side value balance mirror value (step 535).

Next, the details of step 530 and step 535 will be described.

Here, an example of a method of performing update of the server-side value balance mirror value without the payment terminal 6 from the electronic money server 2 to the general-purpose IC chip 25 incorporated into the portable terminal 5 is depicted.

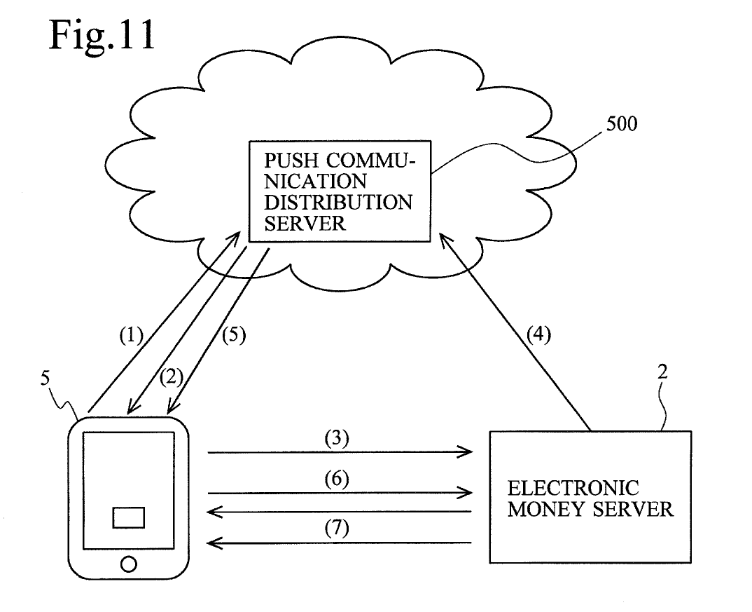

In an example depicted in FIG. 11, a service called “message notification function” by a push communication distribution server 500 is used.

First, the user sends a request from the portable terminal 5 to push the communication distribution server 500. The request is to register portable terminal identification information or an electronic money number (1). At this time, the push communication distribution server 500 acquires the IP address of the portable terminal 5 at the same time. In response to this, the terminal ID by which the portable terminal 5 is identified is sent to the portable terminal 5 from the push communication distribution server 500 (2). The push communication distribution server 500 manages the sent terminal ID and the portable terminal identification information and the IP address as a set in a DB. Incidentally, the portable terminal 5 is configured so as to notify the push communication distribution server 500 of the IP address at regular intervals, and the push communication distribution server 500 manages the latest IP address.

Then, the portable terminal 5 stores the received terminal ID in the storing section 18 and sends this terminal ID to the electronic money server 2 (3).

The electronic money server 2 records the received terminal ID in the user DB in a state in which the terminal ID is associated with the user ID (refer to FIG. 5(a)). This processing from (1) to (3) completes the preparations for using the “message notification function” by the push communication distribution server 500. These processing can be continuously used once these processing is performed.

Then, when the electronic money server 2 receives a payment request sent from the payment terminal 6 and the server-side value balance is updated, this triggers the electronic money server 2 to send the terminal ID recorded in the user DB to the push communication distribution server 500 (4).

The push communication distribution server 500 sends a request to the IP address of the portable terminal 5 by push communication (5). This push communication refers to a type of communication by which information is distributed (forcefully) from the push communication distribution server 500 instead of the portable terminal 5 going and fetching information by itself.

In the portable terminal 5 which has received this request, the electronic money application 29 is started and the state enters a state in which communication with the electronic money server 2 is possible. Then, this electronic money application automatically performs mutual authentication with the electronic money server 2 (6).

When this mutual authentication is successfully performed, the electronic money server 2 sends a subtraction instruction (or an addition instruction) to the portable terminal 5 and, in the portable terminal 5, the electronic money application 29 updates the server-side value balance (7). When this update is completed, “done” is recorded in the item “mirror value update” of the user DB depicted in FIG. 5.

In this example, as depicted in (5), after a request is sent to the portable terminal 5 from the push communication distribution server 500 by push communication, the electronic money server 2 sends a subtraction instruction (or an addition instruction) to the portable terminal 5; however, the electronic money server 2 may send a subtraction instruction (or an addition instruction) to the push communication distribution server 500 in (4) along with the terminal ID. In this case, a subtraction instruction (or an addition instruction) is sent to the portable terminal 5 directly from the push communication distribution server 500, and the server-side value balance is updated by the started electronic money application 29.

Moreover, a notification of a subtraction instruction (or an addition instruction) from the electronic money server 2 may be used as a trigger to start the electronic money application 29 in the portable terminal 5, and this electronic money application 29 may be made to execute the subtraction instruction (or the addition instruction) and update the server-side value balance.

In this example, it is necessary to register a means of identifying the portable terminal 5, for example, an e-mail address in the electronic money server 2 in advance in a state in which the means is associated with the user ID.

### Modified Examples

In step 210 of the third embodiment, the payment terminal 6 compares the payment amount received in step 5 with the server-side value balance mirror value; however, payment may be made if there is simply a value balance mirror value which is more than or equal to a given amount without this comparison. In this case, if there is a shortfall, credit is given to the user.

Moreover, a given number of (for example, one or two) payments from the last update of the mirror value of the value balance may be accepted. Also in this case, if there is a shortfall, credit is given to the user.

Furthermore, payment of a given amount or less (for example, 10,000 yen, 15,000 yen) from the last update of the mirror value of the value balance maybe accepted. Also in this case, if there is a shortfall, credit is given to the user.

In the embodiments described above, descriptions have been given by taking up, as an example, a payment terminal which is installed mainly in a member store of electronic money service, but the embodiment is not limited thereto.

For example, there are payment terminals which are used in the following situations.
A payment terminal which is incorporated into an automatic vending machine . . . Processing between the payment terminal 6 and the general-purpose IC chip 25 and processing (communication) between the payment terminal 6 and the electronic money server 2 are separated from each other, and, when the former is completed, a pseudo payment completion signal is output to a control unit of the automatic vending machine. As a result, the user can get an intended product as if the user used the existing stored value-type electronic money.
A payment terminal which is incorporated into an automatic ticket wicket . . . Processing between the payment terminal 6 and the general-purpose IC chip 25 and processing (communication) between the payment terminal 6 and the electronic money server 2 are separated from each other, and, when the former is completed, a pseudo payment completion signal is output to a control unit of the automatic ticket wicket. As a result, the user can go through the automatic ticket wicket as if the user used the existing stored value-type electronic money.

According to each embodiment, the user can make payment of server-type electronic money as if the user made payment by using the existing asynchronous payment terminal.

Moreover, according to the second embodiment, by using the terminal-side value subsidiarily, it is possible to complete payment quickly even when the server-side value balance is not enough for the payment amount.

Furthermore, according to the third embodiment, the user can update the server-side value balance mirror value stored in the portable terminal without performing processing him/herself.

In addition, according to this third embodiment, since the payment terminal 6 does not update the server-side value balance mirror value, the payment terminal 6 does not have to hold authentication information therein. This makes it possible to reduce the cost of holding the payment terminal 6.

### EXPLANATIONS OF LETTERS OR NUMERALS

1 electronic money system
2 electronic money server
3 the Internet
4 electronic money card
5 portable terminal
6 payment terminal
7 asynchronous payment terminal
8 communication line
11 CPU
12 ROM
13 RAM
14 input section
15 output section
16 communication controlling section
17 short-distance communication controlling section
18 storing section
19 bus line
21 subscriber information IC chip
22 information processing section
23 storing section
25 general-purpose IC chip
26 information processing section
27 storing section
31 CPU
32 ROM
33 RAM
34 communication controlling section
35 storing section
36 bus line
41 CPU
42 ROM
43 RAM
44 input section
45 output section
46 reader/writer
47 storing section
48 communication controlling section
49 bus line
90 electronic money card
500 push communication distribution server

1-7. (canceled)

8. A payment terminal comprising:
a payment amount acquiring means that acquires a payment amount;
a determining means that determines whether or not immediate connection to an information processing server is possible, the information processing server that is accessible to a balance storing means that stores a balance of server-side electronic value in a state in which the balance is associated with terminal identification information by which a money terminal is identified;
a reference amount acquiring means that acquires, from the money terminal, a reference amount of the balance of server-side electronic value, the reference amount stored in the money terminal, after the determining means determines that immediate connection is possible;
a notifying means that notifies the information processing server of the payment amount in a state in which the payment amount is associated with the terminal identification information of the money terminal, such that the balance of server-side electronic value stored in the balance storing means is reduced by the payment amount before new payment processing is started if the payment amount is less than or equal to the reference amount; and
an outputting means that outputs information indicating completion of payment processing with the money terminal, the payment processing related to the payment amount, without waiting for a response to the notification made by the notifying means if the payment amount is less than or equal to the reference amount.

9. The payment terminal according to claim 8, wherein
the money terminal further stores a balance of terminal-side electronic value,
the payment terminal further comprises a terminal-side value balance updating means that sends reduction information to the money terminal, such that the balance of terminal-side electronic value stored in the money terminal is reduced by an amount of difference between the payment amount and the reference amount if the payment amount is not less than or equal to the reference amount, and
the notifying means notifies the information processing server of the reference amount in a state in which the reference amount is associated with the terminal identification information of the money terminal, such that the balance of server-side electronic value stored in the balance storing means is reduced by the reference amount before new payment processing is started if the payment amount is not less than or equal to the reference amount.

10. The payment terminal according to claim 8, further comprising:
a terminal-side reference amount updating means that sends reduction information to the money terminal, such that the reference amount is reduced by the payment amount if the payment amount is less than or equal to the reference amount,
wherein
the outputting means outputs information indicating completion of payment processing with the money terminal, the payment processing related to the payment amount, after the reference amount is reduced by the payment amount.

11. The payment terminal according to claim 10, wherein
the money terminal further stores a number of times of reference indicating a number of times the reference amount is referred to, and
the terminal-side reference amount updating means sends invalidation information to the money terminal, such that the reference amount is invalidated if the number of times of reference acquired from the money terminal is more than or equal to a predetermined threshold value.

12. An information processing server comprising:
a server-side value balance reducing means that reduces the balance of server-side electric value stored in the balance storing means by the amount notified from the notifying means of the payment terminal according to claim 8; and
a sending means that sends reduction information to the money terminal, such that the reference amount stored in the money terminal is reduced by the amount reduced from the balance of server-side value.

13. A payment terminal control method comprising:
a payment amount acquiring step of acquiring a payment amount;
a determining step of determining whether or not immediate connection to an information processing server is possible, the information processing server that is accessible to a balance storing means that stores a balance of server-side electronic value in a state in which the balance is associated with terminal identification information by which a money terminal is identified;
a reference amount acquiring step of acquiring, from the money terminal, a reference amount of the balance of server-side electronic value, the reference amount stored in the money terminal, after determination is made in the determining step that immediate connection is possible;
a notifying step of notifying the information processing server of the payment amount in a state in which the payment amount is associated with the terminal identification information of the money terminal, such that the balance of server-side electronic value stored in the balance storing means is reduced by the payment amount before new payment processing is started if the payment amount is less than or equal to the reference amount; and
an outputting step of outputting information indicating completion of payment processing with the money terminal, the payment processing related to the payment amount, without waiting for a response to the notification output in the notifying step if the payment amount is less than or equal to the reference amount.

14. A non-transitory computer readable medium on which a program product for a computer is recorded, the program product that makes a computer implement:
a payment amount acquiring function of acquiring a payment amount;
a determining function of determining whether or not immediate connection to an information processing server is possible, the information processing server that is accessible to a balance storing means that stores a balance of server-side electronic value in a state in which the balance is associated with terminal identification information by which a money terminal is identified;
a reference amount acquiring function of acquiring, from the money terminal, a reference amount of the balance of server-side electronic value, the reference amount stored in the money terminal, after determination is made by the determining function that immediate connection is possible;
a notifying function of notifying the information processing server of the payment amount in a state in which the payment amount is associated with the terminal identification information of the money terminal, such that the balance of server-side electronic value stored in the balance storing means is reduced by the payment amount before new payment processing is started if the payment amount is less than or equal to the reference amount; and
an outputting function of outputting information indicating completion of payment processing with the money terminal, the payment processing related to the payment amount, without waiting for a response to the notification made by the notifying function if the payment amount is less than or equal to the reference amount.
